(19) United States
(12) Patent Application Publication
(10) Pub. No.: US 2026/0339917 A1
(43) Pub. Date: Oct. 29, 2026

(54) COMPUTER-IMPLEMENTED METHOD OF DISTRIBUTED ADMINISTRATION OF A LOCK, APPRATUS FOR DISTRIBUTED ADMINISTRATION OF A LOCK, AND COMPUTER-PROGRAM PRODUCT

(71) Applicant: BOE Technology Group Co., Ltd., Beijing (CN)

(72) Inventor: Bokai Zhou, Beijing (CN)

(73) Assignee: BOE Technology Group Co., Ltd., Beijing (CN)

(21) Appl. No.: 19/115,984

(22) PCT Filed: Sep. 28, 2023
(86) PCT No.: PCT/CN2023/122513

§ 371 Date: Mar. 27, 2025

(51) Int. Cl. G06F 16/23; G06F 16/21

(52) U.S. Cl. CPC G06F 16/2343; G06F 16/219

(57) ABSTRACT

A computer-implemented method of distributed administration of a lock includes receiving multiple concurrent requests by multiple servers; performing lock preemption to a distributed lock using a synchronization mechanism; acquiring the distributed lock using the synchronization mechanism by only one server; updating, by the only one server, a lock value of the distributed lock; and executing business logic. Performing, by a respective server, lock preemption to the distributed lock includes comparing a current memory value of the distributed lock with an expected value. The method further includes, by the only one server, modifying the current memory value to an updated value if the current memory value matches the expected value; writing the updated value to a memory of the distributed lock; and restoring a memory value of the distributed lock to the current memory value if executing business logic fails.

### TECHNICAL FIELD

The present invention relates to data processing technology, more particularly, to a computer-implemented method of distributed administration of a lock, an apparatus for distributed administration of a lock, and a computer-program product.

### BACKGROUND

In distributed computing environments, where multiple servers or processes need to coordinate their activities, the concept of locks plays a crucial role. A lock is a synchronization mechanism that restricts access to a shared resource, allowing only one entity to access it at a time. Distributed lock management becomes increasingly essential when multiple servers or processes concurrently contend for shared resources.

### SUMMARY

In one aspect, the present disclosure provides a computer-implemented method of distributed administration of a lock, comprising receiving multiple concurrent requests by multiple servers; performing, by the multiple servers, lock preemption to a distributed lock using a synchronization mechanism; acquiring the distributed lock using the synchronization mechanism by only one server of the multiple servers; updating, by the only one server, a lock value of the distributed lock; and executing business logic; wherein performing, by a respective server of the multiple servers, lock preemption to the distributed lock comprises comparing a current memory value of the distributed lock with an expected value; wherein the method further comprises modifying, by the only one server, the current memory value to an updated value if the current memory value matches the expected value; writing, by the only one server, the updated value to a memory of the distributed lock; and restoring, by the only one server, a memory value of the distributed lock to the current memory value if executing business logic fails.

Optionally, performing, by the respective server of the multiple servers, lock preemption to the distributed lock further comprises maintaining the current memory value of the distributed lock unchanged if the current memory value does not match the expected value.

Optionally, performing, by the respective server of the multiple servers, lock preemption to the distributed lock further comprises providing, by a processor, a CPU instruction that atomotically compares the current memory value of the distributed lock with an expected value and updates it if the comparison succeeds.

Optionally, the method further comprises releasing the distributed lock subsequent to restoring the memory value of the distributed lock to the current memory value.

Optionally, the method further comprises utilizing Redis as an underlying data storage and coordination mechanism for the distributed lock; wherein each distributed lock is represented by a specific key-value pair in Redis, where the key represents the lock identifier, and the value represents the lock state or value; a Compare and Swap principle is applied to the Redis key-value pair representing the distributed lock; and when the respective server attempts to preempt the lock, it performs a Compare and Swap operation on a lock value stored in Redis.

Optionally, the method further comprises utilizing Lua scripting for performing atomotic operations and business logic on Redis data.

Optionally, the method further comprises recording, by the only one server, an operation of restoring the memory value.

In another aspect, the present disclosure provides an apparatus for distributed administration of a lock, comprising a data storage and coordination mechanism for a distributed lock; and multiple servers; wherein the multiple servers are configured to receive multiple concurrent requests; and perform lock preemption to a distributed lock using a synchronization mechanism; wherein only one server of the multiple servers is configured to acquire the distributed lock using the synchronization mechanism; update a lock value of the distributed lock; and execute business logic; wherein a respective server of the multiple servers is configured to compare a current memory value of the distributed lock with an expected value; wherein the only one server of the multiple servers is configured to modify the current memory value to an updated value if the current memory value matches the expected value; write the updated value to a memory of the distributed lock; and restore a memory value of the distributed lock to the current memory value if executing business logic fails.

Optionally, the respective server of the multiple servers is configured to maintain the current memory value of the distributed lock unchanged if the current memory value does not match the expected value.

Optionally, the respective server of the multiple servers is configured to provide a CPU instruction that atomotically compares the current memory value of the distributed lock with an expected value and updates it if the comparison succeeds.

Optionally, the only one server of the multiple servers is configured to release the distributed lock subsequent to restoring the memory value of the distributed lock to the current memory value.

Optionally, the data storage and coordination mechanism for the distributed lock is Redis; wherein each distributed lock is represented by a specific key-value pair in Redis, where the key represents the lock identifier, and the value represents the lock state or value; a Compare and Swap principle is applied to the Redis key-value pair representing the distributed lock; and when the respective server attempts to preempt the lock, the respective server is configured to perform a Compare and Swap operation on a lock value stored in Redis.

Optionally, the multiple servers are configured to utilize Lua scripting for performing atomotic operations and business logic on Redis data.

Optionally, the only one server of the multiple servers is further configured to record an operation of restoring the memory value.

In another aspect, the present disclosure provides a computer-program product, comprising a non-transitory tangible computer-readable medium having computer-readable instructions thereon, the computer-readable instructions are executable by one or more processors to cause the one or more processors to perform causing multiple servers to receive multiple concurrent requests; causing the multiple servers to perform lock preemption to a distributed lock using a synchronization mechanism; causing only one server of the multiple servers to acquire the distributed lock using the synchronization mechanism; causing the only one server to update a lock value of the distributed lock; and causing the only one server to execute business logic; wherein the computer-readable instructions being executable by a processor to cause the processor to perform causing a respective server of the multiple servers to compare a current memory value of the distributed lock with an expected value; wherein the computer-readable instructions being executable by a processor to cause the processor to perform causing the only one server to modify the current memory value to an updated value if the current memory value matches the expected value; causing the only one server to write the updated value to a memory of the distributed lock; and causing the only one server to restore a memory value of the distributed lock to the current memory value if executing business logic fails.

Optionally, the computer-readable instructions are executable by one or more processors to cause the one or more processors to perform causing the respective server of the multiple servers to maintain the current memory value of the distributed lock unchanged if the current memory value does not match the expected value.

Optionally, the computer-readable instructions are executable by one or more processors to cause the one or more processors to perform providing a CPU instruction that atomotically compares the current memory value of the distributed lock with an expected value and updates it if the comparison succeeds.

Optionally, the computer-readable instructions are executable by one or more processors to cause the one or more processors to release the distributed lock subsequent to restoring the memory value of the distributed lock to the current memory value.

Optionally, the computer-program product comprises Redis as an underlying data storage and coordination mechanism for the distributed lock; wherein each distributed lock is represented by a specific key-value pair in Redis, where the key represents the lock identifier, and the value represents the lock state or value; a Compare and Swap principle is applied to the Redis key-value pair representing the distributed lock; and when the respective server attempts to preempt the lock, it performs a Compare and Swap operation on a lock value stored in Redis.

Optionally, the non-transitory tangible computer-readable medium having computer-readable instructions comprises Lua scripting for performing atomotic operations and business logic on Redis data.

Optionally, the computer-readable instructions being executable by a processor to further cause the processor to perform causing the only one server to record an operation of restoring the memory value.

### BRIEF DESCRIPTION OF THE FIGURES

The following drawings are merely examples for illustrative purposes according to various disclosed embodiments and are not intended to limit the scope of the present invention.

FIG. 1 illustrates an implementation of distributed locks in some embodiments according to the present disclosure.

FIG. 2 illustrates an implementation of Compare and Swap execution process in some embodiments according to the present disclosure.

FIG. 3 illustrates a computer-implemented method of distributed administration of a lock in some embodiments according to the present disclosure.

FIG. 4 is a flow chart illustrating a computer-implemented method of distributed administration of a lock in some embodiments according to the present disclosure.

FIG. 5 illustrates a computer-implemented method of distributed administration of a lock in some embodiments according to the present disclosure.

FIG. 6 is a flow chart illustrating a computer-implemented method of distributed administration of a lock in some embodiments according to the present disclosure.

FIG. 7 is a flow chart illustrating a computer-implemented method of distributed administration of a lock in some embodiments according to the present disclosure.

FIG. 8 is a flow chart illustrating a computer-implemented method of distributed administration of a lock in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

The present disclosure provides, inter alia, a computer-implemented method of distributed administration of a lock, an apparatus for distributed administration of a lock, and a computer-program product that substantially obviate one or more of the problems due to limitations and disadvantages of the related art. In one aspect, the present disclosure provides a computer-implemented method of distributed administration of a lock. In some embodiments, the method includes receiving multiple concurrent requests by multiple servers; performing, by the multiple servers, lock preemption to a distributed lock using a synchronization mechanism; acquiring the distributed lock using the synchronization mechanism by only one server of the multiple servers; updating, by the only one server, a lock value of the distributed lock; and executing business logic. Optionally, performing, by a respective server of the multiple servers, lock preemption to the distributed lock comprises comparing a current memory value of the distributed lock with an expected value. Optionally, the method further includes modifying, by the only one server, the current memory value to an updated value if the current memory value matches the expected value; writing, by the only one server, the updated value to a memory of the distributed lock; restoring, by the only one server, a memory value of the distributed lock to the current memory value if executing business logic fails; and recording, by the only one server, an operation of restoring the memory value.

In a single-instance application with local deployment, if one needs to synchronize access to a shared variable in a multi-threaded manner, one can use concurrency-related features for mutual exclusion control. However, in the case of multi-instance deployment, where distributed systems have multiple threads and processes spread across different machines, the concurrency control lock strategy used in the original single-instance deployment becomes ineffective. Distributed locks need to be employed to solve this problem. A distributed lock is a mechanism used in distributed systems to achieve mutual exclusion, ensuring that only one node or process can access a shared resource at any given time. In a distributed system, multiple nodes or processes may attempt to access the same resource concurrently, and a distributed lock ensures that only one of them can acquire the lock for that resource, thereby ensuring mutual exclusion. The distributed lock has several advantages.

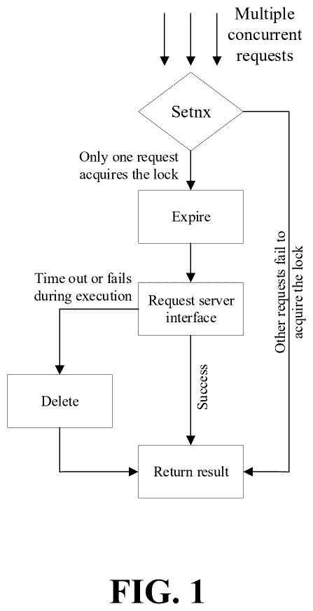

FIG. 1 illustrates an implementation of distributed locks in some embodiments according to the present disclosure. Referring to FIG. 1, multiple concurrent requests are made to acquire the lock. In the example depicted in FIG. 1, the multiple concurrent requests are made to acquire the lock using the SETNX command in Redis. Redis (Remote Dictionary Server) is an open-source, in-memory data structure store that is widely used as a distributed cache, message broker, and database. The SETNX command (“Set if Not Exists”) is a command commonly found in key-value stores, including Redis, that allows one to set the value of a key if the key does not already exist in the database. It provides a way to perform an atomotic operation that creates a key-value pair only if the key is not already present. The SETNX command takes two arguments: the key and the value. It attempts to set the value of the specified key to the given value, but only if the key does not exist. If the key is already present, the command has no effect and returns a result indicating that the key was not set. The purpose of SETNX is to provide an idempotent operation for creating keys, ensuring that the creation of a key-value pair is performed atomotically without the risk of overwriting existing data. If the key does not exist, the command sets the value of the key to the specified value, and returns a result indicating a successful operation (e.g., 1 or “OK”). If the key already exists, the command has no effect; the value of the key remains unchanged, and returns a result indicating that the operation failed (e.g., 0 or null).

In the context of databases or key-value stores like Redis, a “key” refers to a unique identifier that is used to access or reference a specific piece of data or value stored in the database. In a key-value store, data is organized in a simple key-value format, where each value is associated with a unique key. The key serves as an identifier or a handle that allows one to retrieve or manipulate the corresponding value. For example, in Redis, which is a popular in-memory data structure store, one can store data using key-value pairs. The key can be a string, while the value can be any supported data type, such as strings, numbers, lists, sets, or even more complex data structures like hashes or sorted sets. You can use the key to perform various operations such as retrieving the value, updating the value, or deleting the key-value pair. Keys in databases or key-value stores are typically used to provide efficient and fast access to data. They should be unique within the scope of the database or the specific data structure being used, allowing for quick retrieval and manipulation of the associated values.

When a process or node acquires the key associated with a distributed lock, it effectively gains the ability to acquire and hold the lock, thereby granting exclusive access to the shared resource or critical section. In a distributed lock mechanism, the lock is typically associated with a specific key or identifier. Acquiring the key implies that the process or node has obtained the necessary permission or authority to acquire the corresponding distributed lock. Once the lock is acquired by holding the associated key, it signifies that the process or node has obtained exclusive access to the shared resource, and other processes or nodes attempting to acquire the same lock (using the same key) will be blocked or denied access until the lock is released. Granting the key means granting the acquisition of the distributed lock, enabling the holder of the key to control and regulate access to the shared resource in a distributed system.

Referring to FIG. 1 again, the SETNX command is used to set a key (for acquiring the lock) if it does not already exist. Only one request succeeds in setting the key and acquires the lock, while the other requests fail to acquire the lock.

For the request that successfully acquires the lock, the Redis EXPIRE command is used to set an expiration time for the lock. This ensures that the lock will automatically be released after a certain duration if the request does not delete it manually.

The request then proceeds to the server's interface to perform the desired operation. If the request to the server's interface is successful and returns the expected results, the request can return the results to the caller. If the request to the server's interface times out or fails during execution, indicating a failure condition, the request should delete the lock using the DEL command in Redis to release it and then return a failure response to the caller.

The inventors of the present disclosure discover that the method depicted in FIG. 1, which employs a two-step approach (SETNX and EXPIRE), lacks atomoticity. For example, if the service crashes, the lock may encounter issues. The term “atomotically” refers to an operation or a sequence of operations that are guaranteed to occur indivisibly and without interference from concurrent operations. An atomotic operation is one that appears to happen instantaneously, as if it were a single, uninterruptible step, even in the presence of concurrent accesses or interruptions from other threads or processes. The concept of atomoticity is closely related to the idea of consistency and correctness in concurrent or parallel execution. It ensures that a series of operations or a critical section of code is executed in a way that preserves integrity, avoids race conditions, and maintains the desired state or properties of the system. When an operation is performed atomotically, it means that it either completes successfully in its entirety or has no effect at all. There are no partial or intermediate states visible to other threads or processes. This property is crucial for maintaining data integrity, preventing data corruption, and ensuring predictable and correct behavior in concurrent systems.

The inventors of the present disclosure discover that the approach of using SETNX and EXPIRE as separate operations can lead to a situation where a lock is created but not properly released if the requesting process unexpectedly exits or crashes. This can result in a deadlock where subsequent requests are unable to acquire the lock, causing the lock to persist indefinitely.

The inventors of the present disclosure further discover that, if request A acquires a lock, but its business operation takes longer than the expiration time of the lock, request B might acquire the lock and start its own business logic. When request A finally completes and attempts to release the lock, it would unintentionally release the lock held by request B, which violates the integrity of the distributed lock mechanism.

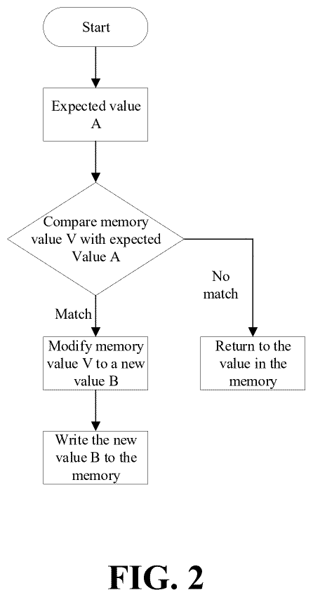

FIG. 2 illustrates an implementation of Compare and Swap execution process in some embodiments according to the present disclosure. Compare and Swap (CAS) is a concurrency control technique used in parallel and distributed computing to achieve atomotic and non-blocking operations on shared variables or memory locations. CAS operations allow one to atomotically compare the current value of a variable with an expected value and, if they match, update the variable to a new value. CAS is a fundamental building block for implementing synchronization primitives like locks, atomotic operations, and optimistic concurrency control mechanisms. In an execution process of Compare and Swap, the current value of a variable is compared with an expected value. If the comparison succeeds (the values match), the operation proceeds to the next step. Otherwise, it indicates that the value has changed in the meantime, and the operation fails. If the comparison succeeds, the variable is updated to a new desired value. The operation returns a result indicating whether the update was successful. It typically returns a Boolean value indicating success or failure.

CAS operations are designed to be performed atomotically and without blocking other operations. They provide a way to achieve synchronization and consistency in a concurrent environment without using traditional locks or blocking mechanisms. The inventors of the present disclosure discover that CAS is particularly useful in scenarios where multiple threads or processes can concurrently access and modify shared variables. By using CAS, race conditions and inconsistencies caused by concurrent updates can be avoided or handled properly.

Referring to FIG. 2, once a current value of the memory location (“memory value V”) is read, the process in some embodiments includes comparing the memory value V with an expected value A. If the comparison succeeds (values match), the process in some embodiments includes modifying memory value V to an updated value B, and writing the updated value B to the memory location. The CAS operation returns a result indicating whether the swap was successful. Typically, it returns a Boolean value indicating success or failure. If the comparison fails (values do not match), the process in some embodiments includes returning the current value stored in the memory location, as it did not match the expected value A. In the CAS process, if the memory value V matches the expected value A, then the updated value B is placed at the memory location. If the memory value V does not match the expected value A, then the value at the memory location is not modified.

The inventors of the present disclosure discover that an ABA problem exists in the CAS process. Specifically, the ABA problem in CAS is a scenario where a memory location or shared variable undergoes a sequence of changes that ultimately result in the same value it had initially, leading to a potential inconsistency or unexpected behavior when using CAS.

The ABA problem can occur in situations where multiple threads or processes concurrently attempt to perform CAS operations on the same memory location. For example, Thread T1 reads the current value of a memory location and obtains the value “A”. Meanwhile, Thread T2 interrupts Thread T1 and performs a series of operations, causing the memory location to change from “A” to “B” and then back to “A”. Subsequently, Thread T1 resumes execution and performs a CAS operation, comparing the current value (“A”) with the expected value (“A”), which matches. Therefore, Thread T1 assumes that no other thread has modified the memory location and proceeds to update it to a new value. In this scenario, Thread T1 successfully performs the CAS operation, even though the memory location has been modified in the meantime. This situation can lead to unexpected behavior and inconsistencies, as Thread T1 is unaware of the intermediate changes that occurred.

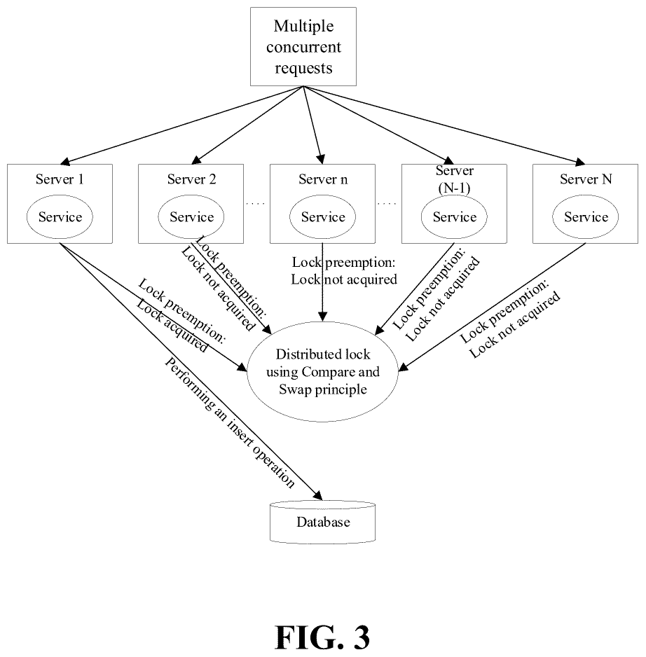

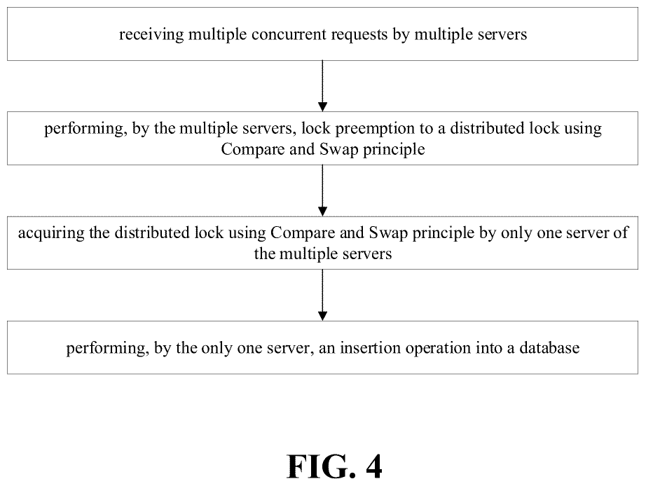

FIG. 3 illustrates a computer-implemented method of distributed administration of a lock in some embodiments according to the present disclosure. FIG. 4 is a flow chart illustrating a computer-implemented method of distributed administration of a lock in some embodiments according to the present disclosure. Referring to FIG. 3 and FIG. 4, the method in some embodiments includes receiving multiple concurrent requests by multiple servers; performing, by the multiple servers, lock preemption to a distributed lock using Compare and Swap principle; acquiring the distributed lock using Compare and Swap principle by only one server of the multiple servers; and performing, by the only one server, an insertion operation into a database.

As shown in FIG. 3, the multiple servers in some embodiments includes N number of servers including Server 1, Server 2, . . . , Server n, . . . , Server (N−1), and Server N. Each server is treated as a service and utilizes a distributed lock mechanism combined with the compare and swap principle to ensure only one server acquires the lock at a time. Once a server has acquired the lock, it performs an insert operation into a database. The inventors of the present disclosure discover that this approach helps prevent conflicts and ensures that only one server/service can perform the insert operation at any given time. While a server holds the lock and performs the insert operation, other servers that attempt to acquire the lock will be blocked or denied access. They will keep retrying until the lock becomes available. Once the server has completed the insert operation and released the lock, another server/service can acquire the lock and perform its own insert operation.

Lock preemption refers to the ability to interrupt or preempt the lock ownership of a server or service by another server or service. For example, lock preemption may mean that, if a server has acquired the lock, it can be preempted or interrupted by another server that has a higher priority or is in a more critical state. When a server attempts to acquire the lock, it checks if any other server currently holds the lock. If the lock is already held by another server/service, the acquiring server evaluates its priority or urgency compared to the current lock holder. If the acquiring server has a higher priority, it preempts the lock ownership from the current lock holder and proceeds to enter the critical section (a specific part of a program or code that must be executed atomotically or in a mutually exclusive manner). The lock ownership is transferred from the current lock holder to the acquiring server. The preempted server is notified that it has lost the lock and should release any resources it was holding related to the critical section. The preempted server can then retry acquiring the lock at a later time or based on a predefined retry mechanism.

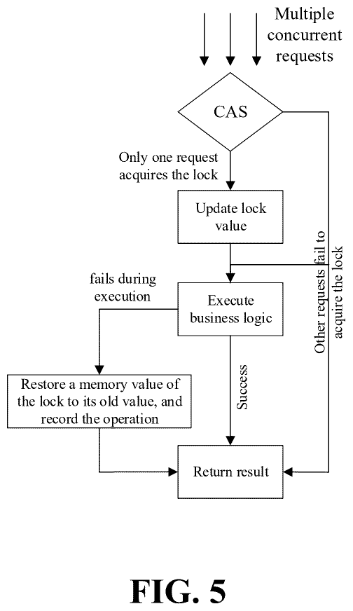

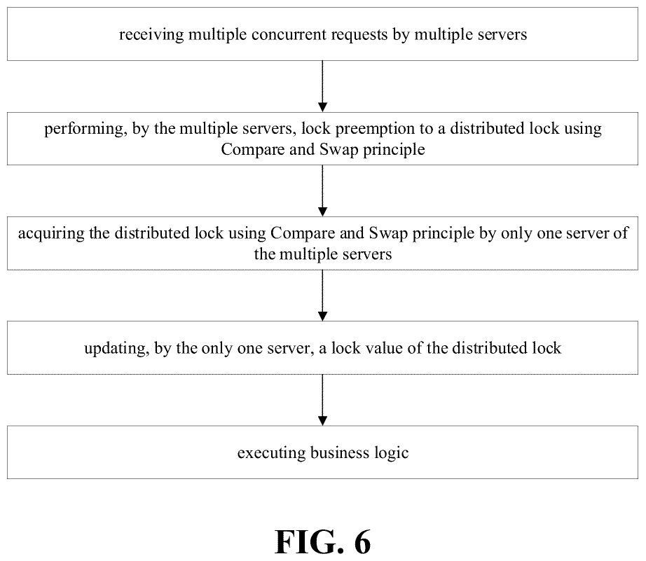

FIG. 5 illustrates a computer-implemented method of distributed administration of a lock in some embodiments according to the present disclosure. FIG. 6 is a flow chart illustrating a computer-implemented method of distributed administration of a lock in some embodiments according to the present disclosure. Referring to FIG. 5 and FIG. 6, the method in some embodiments includes receiving multiple concurrent requests by multiple servers; performing, by the multiple servers, lock preemption to a distributed lock using Compare and Swap principle; acquiring the distributed lock using Compare and Swap principle by only one server of the multiple servers; updating, by the only one server, a lock value of the distributed lock; and executing business logic.

In some embodiments, performing, by a respective server of the multiple servers, lock preemption to the distributed lock using Compare and Swap principle includes comparing a current memory value of the distributed lock with an expected value. In some embodiments, the method further includes modifying, by the only one server of the multiple servers, the current memory value to an updated value if the current memory value matches the expected value; and writing, by the only one server of the multiple servers, the updated value to a memory of the distributed lock. Optionally, performing, by the respective server of the multiple servers, lock preemption to the distributed lock using Compare and Swap principle further includes maintaining the current memory value of the distributed lock unchanged if the current memory value does not match the expected value. The operation in some embodiments involves a CPU instruction that atomotically compares the current memory value of the distributed lock with an expected value and updates it if the comparison succeeds. Processors often provide built-in support for atomotic operations, including Compare and Swap, through specialized CPU instructions. These instructions ensure that the operation is performed atomotically, meaning it is indivisible and cannot be interrupted by other threads or processes.

In some embodiments, the method further includes restoring, by the only one server of the multiple servers, a memory value of the distributed lock to the current memory value (“its old value”) if executing business logic fails; and recording, by the only one server of the multiple servers, an operation of restoring the memory value. By recording the operation of restoring the memory value, relevant information about the operation can be stored in a log or audit trail. Optionally, the relevant information includes details such as the timestamp, the lock identifier, the old value, and any other relevant information you want to track for auditing or debugging purposes. Various appropriate algorithms may be used for restoring the memory value. Examples of appropriate algorithms include rollback mechanisms, undo operations, or transactional approaches to ensure that any modifications made during the unsuccessful execution of business logic are reverted reliably and efficiently.

In some embodiments, the method further includes releasing the distributed lock subsequent to restoring the memory value of the distributed lock to the current memory value. Releasing the distributed lock allows other processes or threads to acquire it.

Various appropriate data storage and coordination mechanisms may be implemented in the present disclosure. Examples of appropriate data storage and coordination mechanisms include Zookeeper, Kafka, etcd, Consul, DynamoDB, Cosmo DB, and Redis.

In some embodiments, the method further includes utilizing Redis as an underlying data storage and coordination mechanism for the distributed lock. For example, Redis serves as the storage medium for maintaining the state of the distributed lock, and provides the necessary capabilities for concurrent access control, atomotic operations, and logging. Each distributed lock is represented by a specific key-value pair in Redis, where the key represents the lock identifier, and the value represents the lock state or value.

In some embodiments, the CAS principle is applied to the Redis key-value pair representing the distributed lock. When a respective server attempts to preempt the lock, it performs a CAS operation on the lock value stored in Redis. This operation compares the current value with an expected value and updates the value if the comparison succeeds, ensuring exclusive lock acquisition.

In some embodiments, in case of business logic failure or other exceptional scenarios, the method can restore the memory value of the distributed lock in Redis using Redis commands or transactions. This ensures the lock value reverts to its previous state, maintaining data consistency.

In some embodiments, Redis provides features for logging and auditing operations. The method in some embodiments can utilize Redis's logging mechanisms to record relevant lock administration operations, including lock value restoration. This enables tracking, analysis, and auditing of lock-related activities.

The inventors of the present disclosure discover that, by utilizing Redis in conjunction with the CAS principle, the method benefits from Redis's efficient data storage and retrieval capabilities, concurrent access control, and logging features. Redis provides a robust foundation for implementing distributed lock management, ensuring scalability, data consistency, and operational transparency.

Various appropriate scripting languages may be implemented in the present disclosure. Examples of appropriate scripting languages include JavaScript, Python, Ruby, Perl, PHP, Go, and Lua.

In some embodiments, the method further includes utilizing Lua scripting for performing atomotic operations and business logic on Redis data. Redis provides a scripting capability through the Lua programming language. Lua scripts can be executed within Redis, allowing for the execution of complex operations on Redis data in an atomotic manner. The inventors of the present disclosure discover that Lua scripting can be used to implement the CAS-based lock preemption mechanism within Redis. The Lua script can perform the comparison of the current lock value with an expected value and update the value if the comparison succeeds, all in an atomotic operation. The inventors of the present disclosure discover that this ensures that only one server successfully acquires the lock. Lua scripting within Redis offers the flexibility to execute complex business logic in the context of the distributed lock management. The inventors of the present disclosure discover that, when a Lua script is executed, it is executed atomotically, it will not be interrupted by other requests. This ensures the atomotic execution of multiple consecutive instructions within the Lua script and preserves the integrity of the task.

By utilizing Lua scripting for performing atomotic operations and business logic on Redis data, the method uses a Lua script to retrieve the current memory value and checks if it is not equal to the expected value. If the check passes, it allows the update to occur. This approach helps avoid the CAS (Compare and Swap) ABA problem.

In some embodiments, the Lua script evaluates the condition and performs the necessary operations to determine if the lock can be acquired. If the condition is met, and the lock is successfully acquired, the Lua script returns a result of 1, indicating that the lock was successfully acquired, and the memory value was updated (returning “true”). If the Lua script returns a result other than 1, it signifies that the lock has been acquired by another instance, and the current request was unsuccessful in acquiring the lock. In this case, the method directly returns “false” to indicate the failure to acquire the lock. By incorporating this logic within the Lua script, the method ensures that only one instance can successfully acquire the lock and update the memory value, while others are notified of the unsuccessful attempt.

In one example, the method includes executing a data insertion functionality every day at a specific time (e.g., at dawn). For example, the method takes two parameters: a first parameter “curr” to obtain the current date when the execution is triggered, and a second parameter “old” to retrieve the original memory value of the lock. Utilizing the CAS principle, if the value provided as the first parameter is not equal to the value of the second parameter, it indicates that the lock has not been acquired by another thread. The current thread can successfully acquire the lock and proceed with executing a business logic. In the event of an error or exception during executing the business logic, the method further includes restoring the lock's value to the old value and record this operation. By restoring the lock value to its previous state, the method ensures the integrity of the lock and maintains consistency in case of failures or errors during executing the business logic.

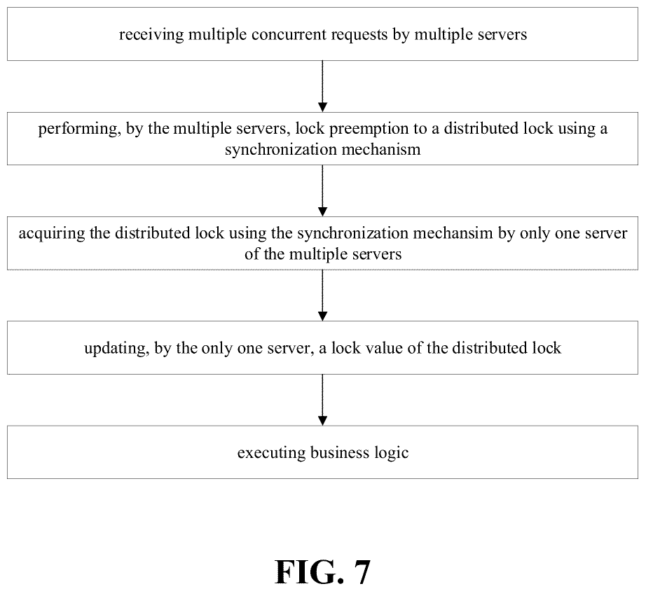

FIG. 7 is a flow chart illustrating a computer-implemented method of distributed administration of a lock in some embodiments according to the present disclosure. Referring to FIG. 7, the method in some embodiments includes receiving multiple concurrent requests by multiple servers; performing, by the multiple servers, lock preemption to a distributed lock using a synchronization mechanism; acquiring the distributed lock using the synchronization mechanism by only one server of the multiple servers; updating, by the only one server, a lock value of the distributed lock; and executing business logic.

A synchronization mechanism is a technique used to coordinate and control concurrent access to shared resources, ensuring that multiple threads or processes can safely access and manipulate the resources without conflicts or data corruption. It helps maintain data integrity and order in a multi-threaded or distributed environment. Various appropriate synchronization mechanisms may be implemented in the present disclosure. Examples of appropriate synchronization mechanisms include Locking, Signaling, Barriers, Atomotic Operations, and Read-Write Locks.

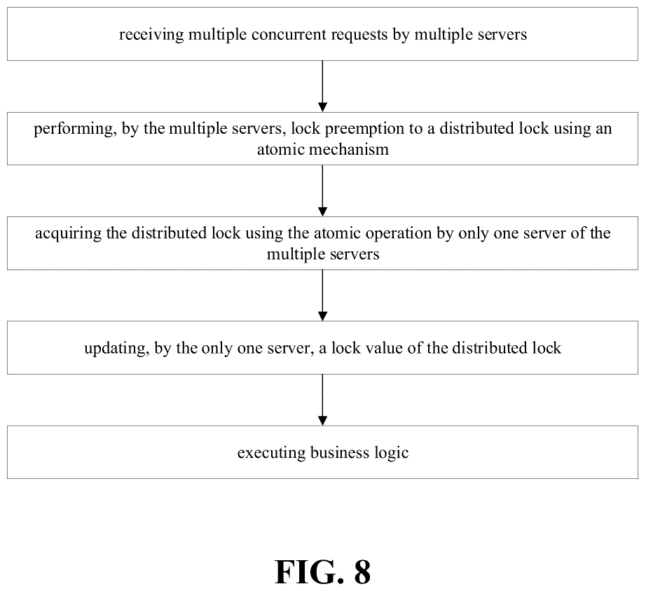

FIG. 8 is a flow chart illustrating a computer-implemented method of distributed administration of a lock in some embodiments according to the present disclosure. Referring to FIG. 8, the method in some embodiments includes receiving multiple concurrent requests by multiple servers; performing, by the multiple servers, lock preemption to a distributed lock using an atomotic operation; acquiring the distributed lock using the atomotic operation by only one server of the multiple servers; updating, by the only one server, a lock value of the distributed lock; and executing business logic. Atomotic operations are low-level operations performed on shared memory that are indivisible and uninterruptible. They ensure that a sequence of operations occurs atomotically, meaning that they are executed as a single, uninterruptible unit without interference from other threads or processes. Atomotic operations provide guarantees of consistency and isolation when multiple threads or processes access shared resources.

Compare and Swap (CAS) is one specific type of atomotic operation that compares the value of a memory location with an expected value and swaps it with a new value if the comparison succeeds. CAS is often used as a building block for implementing synchronization mechanisms, and it is one example of an atomotic operation. Atomotic operations encompass a broader range of operations, such as atomotic read, atomotic write, atomotic increment, atomotic decrement, atomotic add, atomotic subtract, etc. These operations are designed to ensure atomoticity and provide synchronization semantics at a lower level than higher-level synchronization mechanisms. They are typically implemented using hardware support or specific instructions provided by the processor architecture.

In another aspect, the present disclosure provides an apparatus for distributed administration of a lock. In some embodiments, the apparatus includes a data storage and coordination mechanism for a distributed lock; and multiple servers. Optionally, the multiple servers are configured to receive multiple concurrent requests; and perform lock preemption to a distributed lock using a synchronization mechanism. Optionally, only one server of the multiple servers is configured to acquire the distributed lock using the synchronization mechanism; update a lock value of the distributed lock; and execute business logic. Optionally, a respective server of the multiple servers is configured to compare a current memory value of the distributed lock with an expected value. Optionally, the only one server of the multiple servers is configured to modify the current memory value to an updated value if the current memory value matches the expected value; write the updated value to a memory of the distributed lock; restore a memory value of the distributed lock to the current memory value if executing business logic fails; and record an operation of restoring the memory value.

In some embodiments, the respective server of the multiple servers is configured to maintain the current memory value of the distributed lock unchanged if the current memory value does not match the expected value.

In some embodiments, the respective server of the multiple servers is configured to provide a CPU instruction that atomotically compares the current memory value of the distributed lock with an expected value and updates it if the comparison succeeds.

In some embodiments, the only one server of the multiple servers is configured to release the distributed lock subsequent to restoring the memory value of the distributed lock to the current memory value.

In some embodiments, the data storage and coordination mechanism for the distributed lock is Redis. Optionally, each distributed lock is represented by a specific key-value pair in Redis, where the key represents the lock identifier, and the value represents the lock state or value. Optionally, a Compare and Swap principle is applied to the Redis key-value pair representing the distributed lock. Optionally, when the respective server attempts to preempt the lock, the respective server is configured to perform a Compare and Swap operation on a lock value stored in Redis.

In some embodiments, the multiple servers are configured to utilize Lua scripting for performing atomotic operations and business logic on Redis data.

In another aspect, the present disclosure provides a computer-program product comprising a non-transitory tangible computer-readable medium having computer-readable instructions thereon. In some embodiments, the computer-readable instructions are executable by one or more processors to cause the one or more processors to perform causing multiple servers to receive multiple concurrent requests; causing the multiple servers to perform lock preemption to a distributed lock using a synchronization mechanism; causing only one server of the multiple servers to acquire the distributed lock using the synchronization mechanism; causing the only one server to update a lock value of the distributed lock; and causing the only one server to execute business logic.

In some embodiments, the computer-readable instructions being executable by a processor to cause the processor to perform causing a respective server of the multiple servers to compare a current memory value of the distributed lock with an expected value.

In some embodiments, the computer-readable instructions being executable by a processor to cause the processor to perform causing the only one server to modify the current memory value to an updated value if the current memory value matches the expected value; causing the only one server to write the updated value to a memory of the distributed lock; causing the only one server to restore a memory value of the distributed lock to the current memory value if executing business logic fails; and causing the only one server to record an operation of restoring the memory value.

In some embodiments, the computer-readable instructions are executable by one or more processors to cause the one or more processors to perform causing the respective server of the multiple servers to maintain the current memory value of the distributed lock unchanged if the current memory value does not match the expected value.

In some embodiments, the computer-readable instructions are executable by one or more processors to cause the one or more processors to perform providing a CPU instruction that atomotically compares the current memory value of the distributed lock with an expected value and updates it if the comparison succeeds.

In some embodiments, the computer-readable instructions are executable by one or more processors to cause the one or more processors to release the distributed lock subsequent to restoring the memory value of the distributed lock to the current memory value.

In some embodiments, the computer-program product includes Redis as an underlying data storage and coordination mechanism for the distributed lock. Optionally, each distributed lock is represented by a specific key-value pair in Redis, where the key represents the lock identifier, and the value represents the lock state or value. Optionally, a Compare and Swap principle is applied to the Redis key-value pair representing the distributed lock. Optionally, when the respective server attempts to preempt the lock, it performs a Compare and Swap operation on a lock value stored in Redis.

In some embodiments, the non-transitory tangible computer-readable medium having computer-readable instructions comprises Lua scripting for performing atomotic operations and business logic on Redis data.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A computer-implemented method of distributed administration of a lock, comprising:
receiving multiple concurrent requests by multiple servers;
performing, by the multiple servers, lock preemption to a distributed lock using a synchronization mechanism;
acquiring the distributed lock using the synchronization mechanism by only one server of the multiple servers;
updating, by the only one server, a lock value of the distributed lock; and
executing business logic;
wherein performing, by a respective server of the multiple servers, lock preemption to the distributed lock comprises comparing a current memory value of the distributed lock with an expected value;
wherein the method further comprises:
modifying, by the only one server, the current memory value to an updated value if the current memory value matches the expected value;
writing, by the only one server, the updated value to a memory of the distributed lock; and
restoring, by the only one server, a memory value of the distributed lock to the current memory value if executing business logic fails; and
recording, by the only one server, an operation of restoring the memory value.

2. The method of claim 1, wherein performing, by the respective server of the multiple servers, lock preemption to the distributed lock further comprises maintaining the current memory value of the distributed lock unchanged if the current memory value does not match the expected value.

3. The method of claim 1, wherein performing, by the respective server of the multiple servers, lock preemption to the distributed lock further comprises providing, by a processor, a CPU instruction that atomotically compares the current memory value of the distributed lock with an expected value and updates it if the comparison succeeds.

4. The method of claim 1, further comprising releasing the distributed lock subsequent to restoring the memory value of the distributed lock to the current memory value.

5. The method of claim 1, further comprising utilizing Redis as an underlying data storage and coordination mechanism for the distributed lock;
wherein each distributed lock is represented by a specific key-value pair in Redis, where the key represents the lock identifier, and the value represents the lock state or value;
a Compare and Swap principle is applied to the Redis key-value pair representing the distributed lock; and
when the respective server attempts to preempt the lock, it performs a Compare and Swap operation on a lock value stored in Redis.

6. The method of claim 1, further comprising utilizing Lua scripting for performing atomotic operations and business logic on Redis data.

7. The method of claim 1, further comprising recording, by the only one server, an operation of restoring the memory value

8. An apparatus for distributed administration of a lock, comprising:
a data storage and coordination mechanism for a distributed lock; and
multiple servers;
wherein the multiple servers are configured to:
receive multiple concurrent requests; and
perform lock preemption to a distributed lock using a synchronization mechanism;
wherein only one server of the multiple servers is configured to:
acquire the distributed lock using the synchronization mechanism;
update a lock value of the distributed lock; and
execute business logic;
wherein a respective server of the multiple servers is configured to compare a current memory value of the distributed lock with an expected value;
wherein the only one server of the multiple servers is configured to:
modify the current memory value to an updated value if the current memory value matches the expected value;
write the updated value to a memory of the distributed lock; and
restore a memory value of the distributed lock to the current memory value if executing business logic fails.

9. The apparatus of claim 8, wherein the respective server of the multiple servers is configured to maintain the current memory value of the distributed lock unchanged if the current memory value does not match the expected value.

10. The apparatus of claim 8, wherein the respective server of the multiple servers is configured to provide a CPU instruction that atomotically compares the current memory value of the distributed lock with an expected value and updates it if the comparison succeeds.

11. The apparatus of claim 8, wherein the only one server of the multiple servers is configured to release the distributed lock subsequent to restoring the memory value of the distributed lock to the current memory value.

12. The apparatus of claim 8, wherein the data storage and coordination mechanism for the distributed lock is Redis;
wherein each distributed lock is represented by a specific key-value pair in Redis, where the key represents the lock identifier, and the value represents the lock state or value;
a Compare and Swap principle is applied to the Redis key-value pair representing the distributed lock; and
when the respective server attempts to preempt the lock, the respective server is configured to perform a Compare and Swap operation on a lock value stored in Redis.

13. The apparatus of claim 8, wherein the multiple servers are configured to utilize Lua scripting for performing atomotic operations and business logic on Redis data.

14. The apparatus of claim 8, wherein the only one server of the multiple servers is further configured to record an operation of restoring the memory value.

15. A computer-program product, comprising a non-transitory tangible computer-readable medium having computer-readable instructions thereon, the computer-readable instructions are executable by one or more processors to cause the one or more processors to perform:
causing multiple servers to receive multiple concurrent requests;
causing the multiple servers to perform lock preemption to a distributed lock using a synchronization mechanism;
causing only one server of the multiple servers to acquire the distributed lock using the synchronization mechanism;
causing the only one server to update a lock value of the distributed lock; and
causing the only one server to execute business logic;
wherein the computer-readable instructions being executable by a processor to cause the processor to perform:
causing a respective server of the multiple servers to compare a current memory value of the distributed lock with an expected value;
wherein the computer-readable instructions being executable by a processor to cause the processor to perform:
causing the only one server to modify the current memory value to an updated value if the current memory value matches the expected value;
causing the only one server to write the updated value to a memory of the distributed lock; and
causing the only one server to restore a memory value of the distributed lock to the current memory value if executing business logic fails.

16. The computer-program product of claim 15, wherein the computer-readable instructions are executable by one or more processors to cause the one or more processors to perform causing the respective server of the multiple servers to maintain the current memory value of the distributed lock unchanged if the current memory value does not match the expected value.

17. The computer-program product of claim 15, wherein the computer-readable instructions are executable by one or more processors to cause the one or more processors to perform providing a CPU instruction that atomotically compares the current memory value of the distributed lock with an expected value and updates it if the comparison succeeds.

18. The computer-program product of claim 15, wherein the computer-readable instructions are executable by one or more processors to cause the one or more processors to release the distributed lock subsequent to restoring the memory value of the distributed lock to the current memory value.

19. The computer-program product of claim 15, comprising Redis as an underlying data storage and coordination mechanism for the distributed lock;
wherein each distributed lock is represented by a specific key-value pair in Redis, where the key represents the lock identifier, and the value represents the lock state or value;
a Compare and Swap principle is applied to the Redis key-value pair representing the distributed lock; and
when the respective server attempts to preempt the lock, it performs a Compare and Swap operation on a lock value stored in Redis.

20. The computer-program product of claim 15, wherein the non-transitory tangible computer-readable medium having computer-readable instructions comprises Lua scripting for performing atomotic operations and business logic on Redis data.

21. (canceled)
